(19) United States
(12) Patent Application Publication
(10) Pub. No.: US 2007/0228004 A1
(43) Pub. Date: Oct. 4, 2007

(54) Device and method for the treatment of wafers

(76) Inventors: Juergen-Werner Molkenthin, Langenbrettach (DE); Doris Ottenlinger, Leingarten (DE)

Correspondence Address: MCGRATH, GEISSLER, OLDS & RICHARDSON, PLLC, P.O. BOX 1364, FAIRFAX, VA, 22038-1364, US

(21) Appl. No.: 11/730,918

(22) Filed: Apr. 4, 2007

(30) Foreign Application Priority Data
Apr. 4, 2006 (DE) DE 102006015759.1

(51) Int. Cl. C03C 25/68; C23F 1/00

(52) U.S. Cl. 216/55; 156/345.37; 216/66; 216/62

(57) ABSTRACT

A device and a method is provided for irradiating wafers with low-intensity UV light to prevent blistering during the subsequent photostabilization of the photoresist.

This nonprovisional application claims priority under 35 U.S.C. § 119(a) on German Patent Application No. DE 102006015759, which was filed in Germany on Apr. 4, 2006, and which is herein incorporated by reference.

### BACKGROUND OF THE INVENTION

1. Field of the Invention

The present invention relates to a device and a method for the treatment of wafers.

2. Description of the Background Art

Integrated circuits, such as microprocessors or memory chips, and other similar assemblies are typically produced on thin, round disks, so-called wafers. These undergo many successive process steps during their fabrication, including process steps in which the photoresist mask present on the wafers is stabilized by means of temperature and ultraviolet light.

The photoresist structure generated during the lithographic process is insufficiently resistant to the temperatures arising during subsequent processes such as, e.g., ion implantation and dry etching processes, or to the employed process gases. For this reason, the photoresist mask is stabilized to improve the selectivity in dry etching processes and the uniformity of the critical dimensions, and to reduce particle generation during the ion implantation process. This process is generally known as photostabilization.

In this regard, the photoresist is first irradiated with ultraviolet light at a low temperature to break down the light-sensitive component, the PAC (PAC=photoactive component), and to stabilize the resist profile.

Current light-sensitive PACs have, e.g., cyclic, often benzannelated α-diazoketones as functional chemical groups, as can be seen in the following compound:

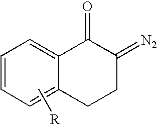

Next, during further simultaneous irradiation with UV light, the temperature is increased to remove the solvent still present in the photoresist and to crosslink the photoresist resin.

High-intensity UV lamps are used to carry out the destruction of the PACs within a short time. In addition, the power-time profile is directed primarily at the crosslinking of the photoresist resin.

The reaction of the photoactive component with ultraviolet light occurs with the cleavage of nitrogen, which is formed by a photo-Wolff rearrangement according to the following mechanism:

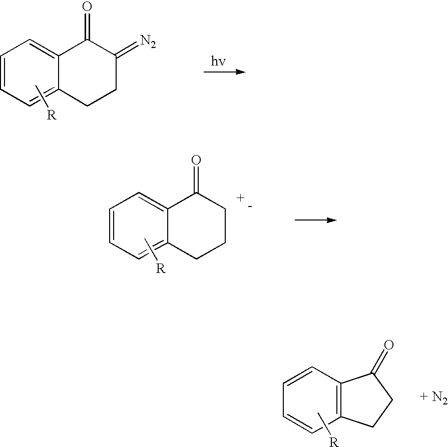

A ketene, which is hydrolyzed further, however, e.g., to an (optionally substituted) indole carboxylic acid or otherwise functionalized, therefore forms as a reaction product, in addition to nitrogen, initially by ring contraction.

In this case, the amount of the forming nitrogen depends proportionally on the light intensity of the UV light and the thickness of the photoresist. If the photoresist thickness and/or light intensity are very great, the forming nitrogen can break down the resist layer due to incipient bubble formation. This effect is called “blistering.” If the bubbles burst, portions of the photoresist are dissolved, which is called ‘popping’, and represent a source of particles. To counteract this effect, in modern plants, for photostabilization the exposure to UV light is broken down into individual light flashes, to allow the formed nitrogen to escape between the flashes. This approach, however, is not suitable for all applications to effectively circumvent “blistering.”

It is a disadvantage of known UV stabilization devices that with a reduced resist adhesion to the wafer surface and preferentially in wafers with a cut section, called a flat, in whose area the resist thickness is a multiple of the sought resist thickness on the wafer, the aforementioned effects of bubble formation, the bursting of the bubbles, and the resulting particle generation are present and occur latently.

The forming particles can distribute themselves over the wafer surface and during subsequent patterning processes such as, e.g., etching or implementation processes lead to local masking, which leads to short circuits and breaks.

These described problems occur particularly in wafers with so-called “flats,” because due to the application of the photoresist by spin coating, these have a higher photoresist thickness especially in the flat area and thereby the risk of blistering also occurs increasingly.

### SUMMARY OF THE INVENTION

It is therefore an object of the present invention to provide a device and a method for the treatment of wafers, in which the above disadvantages are avoided or at least largely reduced and which enable subsequent curing of the photoresist without quality losses in the wafers.

Accordingly, a device for irradiating wafers, particularly wafers having a flat, is provided, wherein at least one irradiation unit, whereby the at least one irradiation unit has a power of ≧2 W to ≦300 W in the ultraviolet range.

“Ultraviolet range” is taken to mean particularly the range of from ≧350 nm to ≦450 nm.

“Irradiation unit” within the meaning of the present invention is taken to mean particularly a UV lamp.

It is noted that for the case in which a plurality of irradiation units, such as, for instance, two or more UV lamps, are disposed in the device, the “power of the irradiation unit” according to claim 1 means the sum of the individual powers of the individual irradiation units; e.g., if three 10-W UV lamps are present, the power can be 30 W.

It turned out that surprisingly during irradiation with a power of from ≧2 W to ≦300 W in the ultraviolet range, the PAC component in most applications reacts largely without “blistering” and a smooth structure can be achieved during subsequent curing in most applications of the present invention.

The at least one irradiation unit has a power of from ≧4 W to ≦250 W, more preferably from ≧6 W to ≦200 W, even more preferably between ≧8 W to ≦100 W, still more preferably between ≧10 W to ≦50 W, and most preferably between ≧12 W to ≦20 W in the ultraviolet range.

It is noted that according to an embodiment of the present invention, the entire surface or substantially the entire surface of the wafer is irradiated; according to another embodiment, only a portion of the surface of the wafer is irradiated.

According to an embodiment of the present invention, a portion of the surface of the wafer, which includes the flat area, is irradiated. Preferably, this is the flat area and possibly the areas adjacent thereto of the wafer.

Because of the increased thickness of this area, use of the present invention in these wafers is especially advantageous. It turned out that in some applications within the present invention only the flat area must be irradiated by the device of the invention or the method of the invention, whereas the “conventional” UV curing process is sufficient for the rest of the area to prevent blistering.

According to an embodiment of the present invention, the radiation intensity on the wafer is from ≧0.5 mW/m² to ≦2.5 mW/m², preferably from ≧1 W/m² to ≦1.5 mW/m².

This proved to be advantageous for a broad range of applications within the present invention, because the irradiation often proceeds in this way with no secondary reactions.

According to an embodiment of the present invention, the resist thickness of the wafer at least in the areas irradiated by the irradiation unit is from ≧3 μm to ≦20 μm, preferably from ≧5 μm to ≦15 μm.

According to another embodiment of the present invention, the distance between the irradiation unit and the wafers to be irradiated is between ≧2 cm to ≦40 cm.

If several irradiation units are provided in the device of the invention, preferably the average distance between the irradiation units and the wafers to be irradiated is between ≧2 cm to ≦40 cm.

For the case that a plurality of wafers are to be irradiated in the device, it is preferred that all wafers are located within said distance to the at least one irradiation unit.

It turned out that in many applications of the present invention a certain minimum distance increases the quality of the irradiation; it also turned out in many applications that the radiation quality declines beyond a certain distance.

The (average) distance between the at least one irradiation unit and the wafers to be irradiated can be between ≧3 cm to ≦30 cm, more preferably between ≧4 cm to ≦20 cm.

According to an embodiment of the present invention, the average distance between two wafers to be irradiated is at least ≧0.5 mm. It turned out in many applications that a certain minimum distance also has a good effect on the quality of the irradiation, in order to prevent a wafer being located in the irradiation run of a preceding or subsequent wafer.

The average distance between two wafers to be irradiated can be between ≧0.5 mm and ≦15 mm, more preferably between ≧1 mm and ≦10 mm, and most preferably between ≧2 mm and ≦8 mm.

The wafers are arranged in the device preferably parallel or substantially parallel to one another.

According to an embodiment of the present invention, the light emitted by the at least one irradiation unit reaches the wafer at an angle α between ≧70° to ≦110°. This has proven especially beneficial for a uniform and efficient irradiation.

The light emitted by the at least one irradiation unit reaches the wafer at an angle α between ≧75° to ≦100°, more preferably between ≧80° to ≦95°.

According to an embodiment of the present invention, angle β, i.e., the alignment line over the wafer edges, is between ≧15° to ≦90°. In many applications within the present invention, this has proven beneficial, because especially many wafers can be irradiated in this way without loss of quality.

Angle β can be between ≧20° to ≦55°, more preferably between ≧25° to ≦40°.

The present invention also relates to a method for irradiating wafers, particularly in a device as described above, which is characterized in that the wafers are irradiated with a power of ≧2 W to ≦300 W in the ultraviolet range.

The wafers can be irradiated with a power of from ≧4 W to ≦250 W, more preferably from ≧6 W to ≦200 W, even more preferably between ≧8 W to ≦100 W, still more preferably between ≧10 W to ≦50 W, and most preferably between ≧12 W to ≦20 W in the ultraviolet range.

According to an embodiment of the present invention, the wafers are irradiated at a distance between ≧2 cm to ≦40 cm, more preferably between ≧3 cm to ≦30 cm, and still more preferably between ≧4 cm to ≦20 cm from the radiation source.

According to an embodiment of the present invention, the light used for irradiation reaches the wafer at an angle α between ≧70° to ≦110°, more preferably between ≧75° to ≦100°, and still more preferably between ≧80° to ≦95°.

According to an embodiment of the present invention, angle β, i.e., the alignment line over the wafer edges, is between ≧15° to ≦90°, more preferably between ≧20° to ≦55°, and still more preferably between ≧25° to ≦50°.

According to an embodiment of the present invention, the irradiation time is between ≧1 minute to ≦40 minutes. It turned out that this irradiation time is sufficient for virtually all applications of the present invention to achieve both a sufficient reaction of the PAC and not to stress the wafers too greatly.

“Irradiation time” is taken to mean in particular the time during which the wafers are irradiated. This time according to an embodiment of the invention can be interrupted to give the released nitrogen time to escape from the wafers. In many applications of the present invention, it turned out, however, that interruption of the irradiation is not necessary, so that according to a preferred embodiment of the invention the irradiation occurs without interruption.

The irradiation time can be between ≧2.5 minutes to ≦20 minutes, more preferably between ≧5 minutes to ≦15 minutes.

According to an embodiment of the present invention, the energy output (in wattage*time) is between ≧50 W*min to ≦200 W*min. It turned out that in many applications this is advantageous for a good irradiation without excessive stress of the wafers.

“Time” in this case is taken to mean the irradiation time.

The energy output (in wattage*time) can be between ≧75 W*min to ≦180 W*min, more preferably between ≧100 W*min to ≦150 W*min.

According to an embodiment of the present invention, the energy output per micrometer of thickness of the photoresist layer to be irradiated (in wattage*time/μm of thickness) is between ≧5 W*min/μm to ≦25 W*min/μm.

Particularly, in applications in which primarily the flat area of the wafer is irradiated, it proved especially advantageous to adjust the energy output of the irradiation in this way to the thickness of the photoresist layer to be irradiated.

For the case that the wafer does not have a uniform thickness of the photoresist layer in the area to be irradiated, according to a preferred embodiment, the energy output per micrometer of average thickness of the photoresist layer to be irradiated (in wattage*time/μm of average thickness) is between ≧5 W*min/μm to ≦25 W*min/μm.

Preferably, the energy output per micrometer of (optionally average) thickness of the photoresist layer to be irradiated (in wattage*time/μm of thickness) is between ≧8 W*min/μm to ≦20 W*min/μm, preferably between ≧10 W*min/μm to ≦17.5 W*min/μm.

According to an embodiment of the present invention, the irradiation is performed in such a way that the temperature of the irradiated wafer, at least in the parts exposed to the radiation, is between ≧15° C. to ≦30° C.

This has proven advantageous within a broad range of applications within the present invention, because it is often possible to further suppress secondary reactions.

The aforementioned as well as the claimed components, and those described in the exemplary embodiments and to be used according to the invention are not subject to any special exceptions as to their size, design, material selection, and conceptual technical design, so that the selection criteria known in the field of application can be applied without limitation.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic perspective view of the device according to a first embodiment of the invention;

FIG. 2 is a schematic side view of the wafer of FIG. 1 to clarify the angles αand β;

FIG. 3 is a photograph of a wafer in side view after curing of the photoresist layer without prior irradiation (state of the art); and

FIG. 4 a photograph of a wafer in side view after curing of the photoresist layer, treatment according to the invention having been performed previously.

### DETAILED DESCRIPTION

FIG. 1 shows a schematic perspective view of device 1 according to an embodiment of the invention. In this device, about 20-30 wafers can be irradiated at one time, but in FIG. 1 only two wafers 10a, 10b are shown for reasons of clarity.

The device comprises a receptacle 20 for wafers 10a, 10b, and an irradiation unit 30 for irradiating the wafer. In the present embodiment, the irradiation unit consists of two UV lamps disposed next to each other, but all other irradiation units known to the person skilled in the art can be used, provided their power lies within the aforementioned range.

The present embodiment of the invention relates particularly to wafers that have a flat area. These are placed in the receptacle with the flat area facing upward and then irradiated as described above. Typically, no other process step such as an after-treatment is necessary; the wafers can be subjected immediately to further processing steps, such as the previously described photostabilization.

Receptacle 20 and irradiation unit 30 are disposed in such a way that the angle α (i.e., the angle at which the UV light reaches the wafer) and the angle β (i.e., the alignment line over the wafer edges) are approximately 90° or 20-25°, respectively.

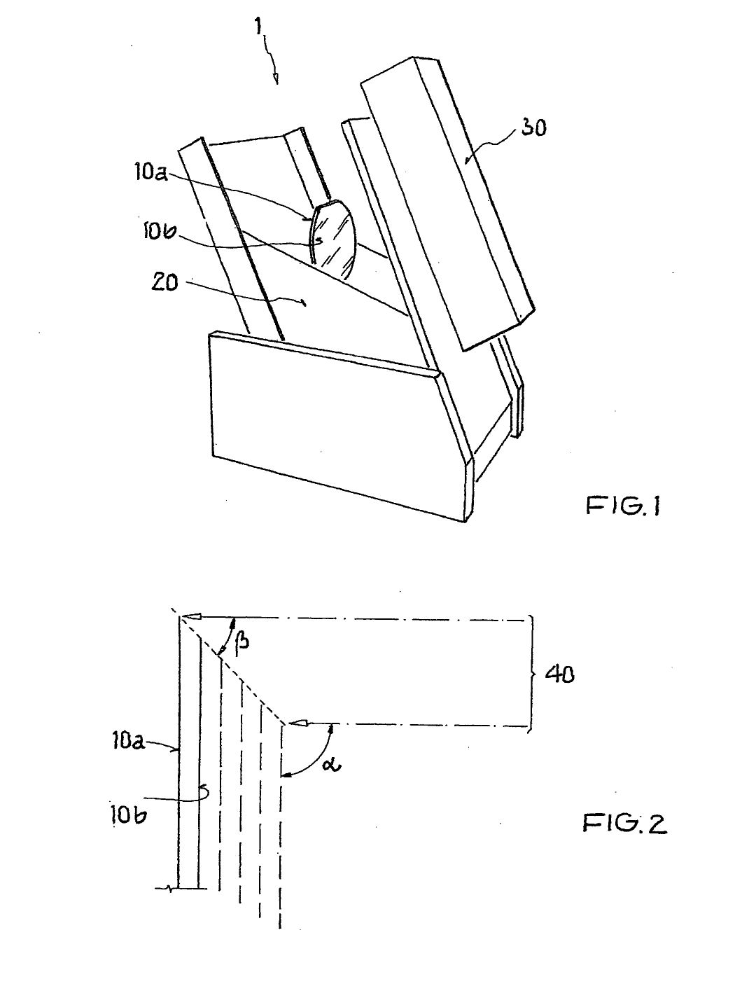

For clarification, FIG. 2 shows a schematic side view of the wafers of FIG. 1, several wafers (dashed lines) having been drawn in addition. The alignment line of the wafer edges of wafers 10a, 10b (and other wafers) forms approximately an angle β, of 20-25°, whereas UV light 40 reaches wafer 10a, 10b at about 90° (angle α).

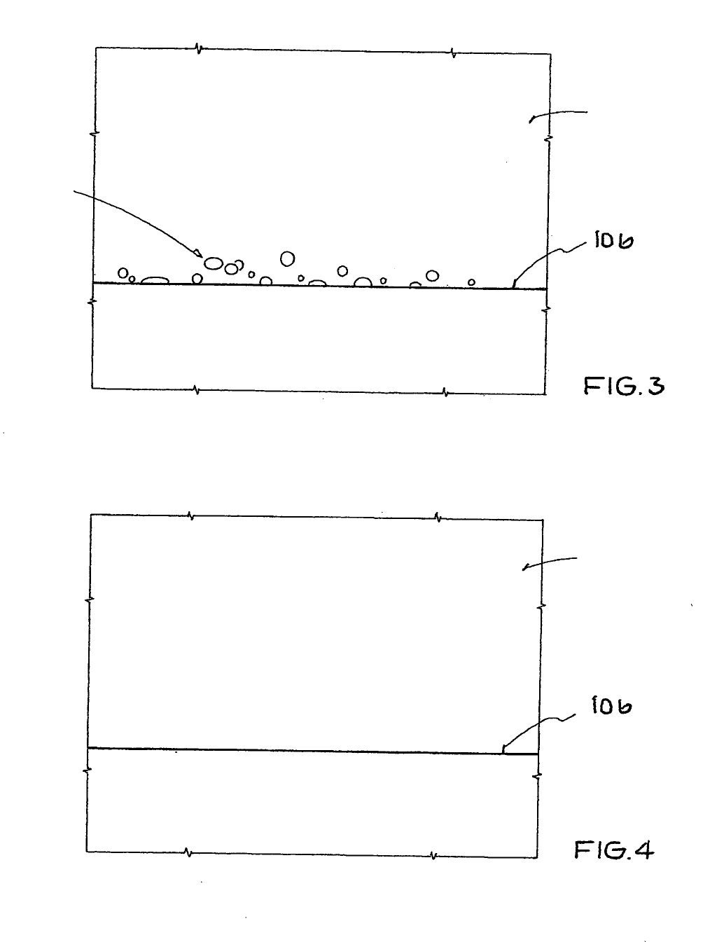

FIG. 3 shows a photograph of a wafer in a front view after photostabilization of the photoresist layer without previous irradiation (state of the art), and FIG. 4 a photograph of a front view after photostabilization of the photoresist layer, treatment according to the invention having been previously performed.

It is evident that in the photoresist layer in FIG. 3, i.e., a wafer according to the state of the art, bubbles are clearly evident which were produced by the released N₂. The resist layer in FIG. 3 has even burst in some places, which considerably reduces the quality of the wafer.

On the contrary, the wafers subjected to the method of the invention have a smooth resist layer, as is evident in FIG. 4.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A device for irradiating wafers having a flat, the device comprising at least one irradiation unit having a power of 2 W to 300 W in an ultraviolet range.

2. The device according to claim 1, wherein the distance between the irradiation unit and the wafers to be irradiated is between 2 cm to 40 cm.

3. The device according to claim 1, wherein the light emitted by the at least one irradiation unit reaches the wafer at an angle between 70° to 110°.

4. The device according to claim 1, wherein the angle or the alignment line over wafer edges is between 15° to 90°.

5. The device according to claim 1, wherein the radiation intensity on the wafer is from ≧0.5 mW/m² to ≦2.5 mW/m².

6. A method for irradiating wafers in a device having at least one irradiation unit, wherein the wafers are irradiated with a power of 2 W to 300 W in the ultraviolet range.

7. The method according to claim 6, wherein the irradiation time is between 1 minute to 40 minutes.

8. The method according to claim 6, wherein the energy output (in wattage*time) is between 50 W*min to 200 W*min.

9. The method according to claim 6, wherein the energy output per micrometer of thickness of the photoresist layer to be irradiated (in wattage*time/μm of thickness) is between 5 W*min/μm to 25 W*min/μm.

10. The method according to claim 6, wherein the temperature of the irradiated wafer, at least in the parts exposed to the radiation, is between ≧15° C. to ≦30° C.
